(19) United States
(12) Patent Application Publication
(10) Pub. No.: US 2026/0203217 A1
(43) Pub. Date: Jul. 16, 2026

(54) PROGRESSIVE SYSTEM FOR ACQUIRING HOT DATA AND METHOD FOR RECOGNIZING HOT DATA

(71) Applicant: TrustTeks Ltd., Hsinchu City (TW)

(72) Inventor: YUAN-MAO CHANG, Hsinchu City (TW)

(21) Appl. No.: 19/018,784

(22) Filed: Jan. 13, 2025

(51) Int. Cl. G06F 12/0802

(52) U.S. Cl. CPC G06F 12/0802; G06F 2212/60

(57) ABSTRACT

A progressive system for acquiring hot data is used to access data in a computer and connected to a data-providing module. The progressive system includes a filter device and a hot-data storing device. The filter device includes a preliminary filter and an advanced filter. The preliminary filter receives a new data record from the data-providing module. The preliminary filter determines whether the new data record is a previously-stored data record. If yes, it outputs a preliminary data record. If not, it stores the new data record. The advanced filter is coupled to the data-providing module and the preliminary filter. The advanced filter receives and stores the preliminary data record. The advanced filter further serves to determine whether a new data record is a previously-stored data record. If yes, it outputs an advanced data record. The hot-data storing device is coupled to the advanced filter and stores the advanced data record.

### BACKGROUND OF THE DISCLOSURE

### 1. Technical Field

This disclosure relates to systems and methods for accessing data in computers, and more particularly to a progressive system for acquiring hot data and a method for recognizing hot data.

### 2. Description of Related Art

In a computer system, a central processing unit (CPU), a cache, a random-access memory (RAM), and a hard disk work together to implement effective data processing and storage. Therein, the CPU is like the brain of the computer and serves to execute instructions and perform computing. Specifically, when there is a need for data processing, the CPU loads and executes relevant instructions. For speeding up data access, the computer may use the cache to temporarily store the most used data and instructions. Thus, when the CPU needs a certain set of data, it checks the cache first. If the data set is found in the cache, the search process is finished quickly. Otherwise, it turns to the memory for further search. The cache features for fast access but its price is usually high. The RAM is a temporary storage area in the computer and is where applications and data currently in use are kept. As compared to the cache, the RAM may have higher capacity but requires longer access time. The hard disk is a persistent storage device, which requires the longest access time. It stores operating systems, applications, and data. When the computer is powered on, the operating systems and some frequently used programs are loaded to the RAM from the hard disk for the computer to execute them faster. Further, some frequently used data are kept in the cache for the most efficient operation.

In general, the foregoing process for accessing data represents a hierarchical system, wherein storage devices of different levels are different in terms of speed and capacity to satisfy demands of the computer for both fast data access and temporary storage. This cooperation ensures that the computer can execute complex tasks with high efficiency. However, as the demand for fast data access in computers increases, simply expanding caches or memories in capacity is no longer a feasible solution due to economic consequences. Hence, there is a need for a solution that effectively accelerates data access with economic benefits taken into account.

### SUMMARY OF THE DISCLOSURE

The primary objective of the present disclosure is to satisfy the foregoing need by speeding up access to data in a computer.

To achieve the foregoing objective, in one embodiment, this disclosure provides a progressive system for acquiring hot data. The progressive system is for accessing data in a computer and is connected to a data-providing module. The progressive system for acquiring hot data comprises a filter device and a hot-data storing device. The filter device comprises a preliminary filter and an advanced filter. The preliminary filter comprises a preliminary input unit, a preliminary processor unit, a preliminary storage unit, and a preliminary output unit. The preliminary input unit is coupled to the data-providing module to receive a new data record from data-providing module. The preliminary processor unit determines whether the new data record is a previously-stored data record. If yes, the preliminary output unit outputs a preliminary data record. If not, the new data record is stored in the preliminary storage unit. The advanced filter is coupled to the data-providing module and the preliminary filter. The advanced filter comprises a serial input unit, an advanced input unit, an advanced processor unit, an advanced storage unit, and an advanced output unit. The serial input unit is coupled to the preliminary output unit. The serial input unit receives the preliminary data record and stores the preliminary data record to the advanced storage unit. The advanced input unit is coupled to the data-providing module and receives the new data record. The advanced processor unit determines whether the new data record is a previously-stored data record. If yes, the advanced output unit outputs an advanced data record. The hot-data storing device is coupled to the advanced filter and stores the advanced data record.

This disclosure further provides a method that uses the aforementioned system to recognize hot data. The method is related to prioritize data in a computer. The method comprises a data-inputting step, a first data-determining step, a second data-determining step, and a hot data-storing step. The data-inputting step involves providing a new data record to the filter device through the data-providing module. The first data-determining step is for determining whether the new data record is a previously-stored data record in the advanced filter of the filter device, and if yes, having the advanced filter output an advanced data record corresponding to the new data record, or if no, performing the second data-determining step. The second data-determining step involves determining whether the new data record is a previously-stored data record in the preliminary filter of the filter device, and if yes, having the preliminary filter output a preliminary data record corresponding to the new data record to the advanced filter, or if no, storing the new data record in the preliminary filter. The hot data-storing step involves storing the advanced data record through the hot-data storing device.

Thereby, this disclosure can use the filter device and the hot-data storing device to progressively recognize and access hot data in a computer, so as to improve the overall speed of data access in the computer.

### BRIEF DESCRIPTION OF THE DRAWINGS

FIG. 1 is a block diagram of a progressive system for acquiring hot data according to one embodiment of this disclosure.

FIG. 2 is a block diagram of a progressive system for acquiring hot data according to another embodiment of this disclosure.

FIG. 3 is a block diagram of a filter device according to one embodiment of this disclosure.

FIG. 4 is a block diagram of a filter device according to another embodiment of this disclosure.

FIG. 5 is a logic diagram of a progressive system for acquiring hot data according to one embodiment of this disclosure.

FIG. 6 is a logic diagram of a progressive system for acquiring hot data according to another embodiment of this disclosure, showing plural advanced filters.

FIG. 7 is a logic diagram of a progressive system for acquiring hot data according to another embodiment of this disclosure, showing a sieve incorporated.

FIG. 8 is a logic diagram of a progressive system for acquiring hot data according to another embodiment of this disclosure, showing plural sieves incorporated.

FIG. 9 is a flowchart of a method for recognizing hot data according to one embodiment of this disclosure.

FIG. 10 is a flowchart of a method for recognizing hot data according to another embodiment of this disclosure.

### DETAILED DESCRIPTION OF THE DISCLOSURE

While preferred embodiments will be provided hereinafter for illustrating the concept of the present disclosure, it is to be understood that the components of the embodiments shown in the accompanying drawings are depicted for the sake of easy explanation and need not to be made to exact scale.

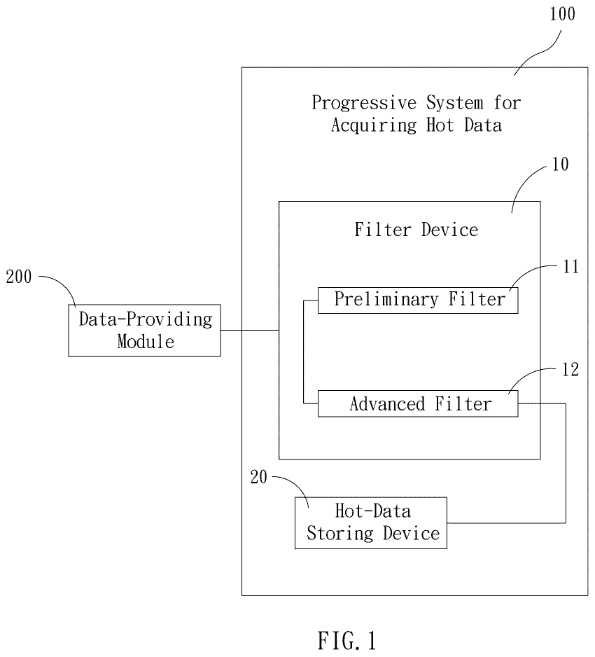

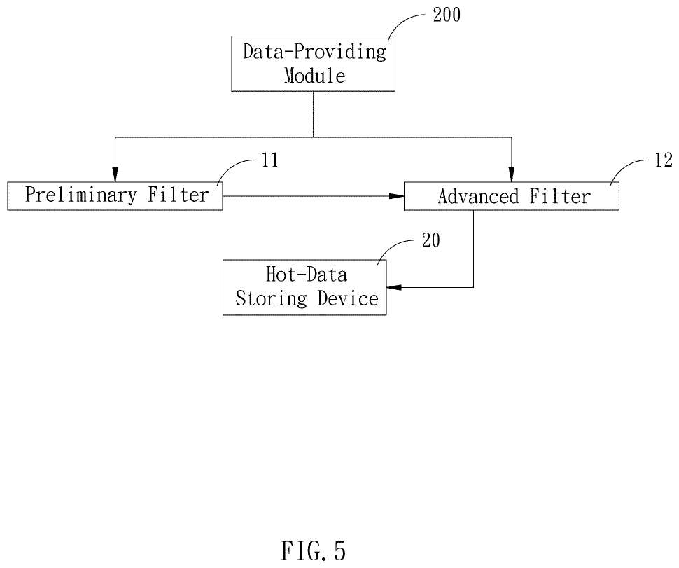

Referring to FIG. 1 through FIG. 10, in one embodiment, this disclosure provides a progressive system for acquiring hot data 100. It is for accessing data in a computer and is connected to a data-providing module 200. The progressive system 100 comprises a filter device 10 and a hot-data storing device 20. Therein, the data-providing module 200 serves to provide a new data record to the progressive system 100 so that the progressive system 100 determines how to store the new data record for the optimal efficiency of operation of the computer.

The filter device 10 comprises a preliminary filter 11 and an advanced filter 12. In the present embodiment, the preliminary filter 11 and the advanced filter 12 may each be a Bloom filter. Specifically, the preliminary filter 11 and the advanced filter 12 may each be a counting Bloom filter so as to use the accumulative counting mechanism of the counting Bloom filters to achieve more efficient data access.

The preliminary filter 11 comprises a preliminary input unit 111, a preliminary processor unit 112, a preliminary storage unit 113, and a preliminary output unit 114. The preliminary input unit 111 is coupled to the data-providing module 200 and receives the new data record from the data-providing module 200. The preliminary processor unit 112 determines whether the new data record is a previously-stored data record. If yes, the preliminary output unit 114 outputs a preliminary data record. If no, the new data record is stored in the preliminary storage unit 113. Therein, the preliminary processor unit 112 determines whether the new data record is a previously-stored data record by searching in the preliminary storage unit 113 for any data record identical to the new data record. If there is a data record in the preliminary storage unit 113 that is identical to the new data record, the preliminary processor unit 112 recognizes the new data record as the preliminary data record, and lets the preliminary output unit 114 output the preliminary data record. In this case, the identical data record in the preliminary storage unit 113 is deleted by the preliminary processor unit 112.

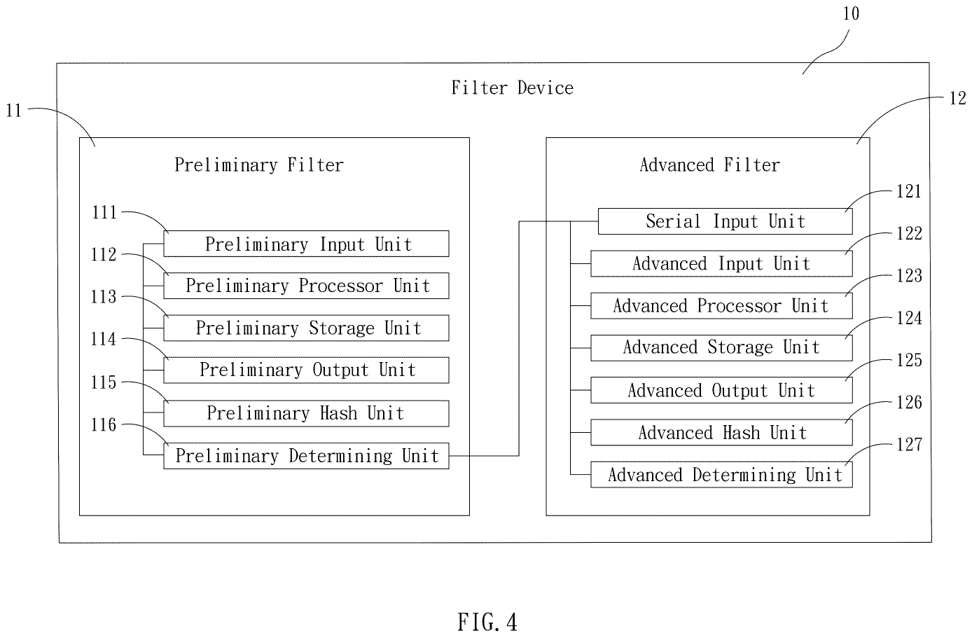

Referring to FIG. 4, in the present embodiment, the preliminary filter 11 further comprises a preliminary hash unit 115. The preliminary hash unit 115 receives and hashes the new data record to obtain a hashed-form data record. The preliminary processor unit 112 determines whether the hashed-form data record is a previously-stored data record. As described previously, the preliminary filter 11 may be a Bloom filter. Specifically, the preliminary filter 11 may be a counting Bloom filter. Thus, with the use of the preliminary hash unit 115, every new data record can be represented and stored in the hashed form. The preliminary processor unit 112 determines whether there is any identical hashed-form data record at the corresponding storage site in the preliminary storage unit 113. If yes, the preliminary processor unit 112 recognizes the hashed-form data record as a previously-stored data record.

Referring to FIG. 4, in one embodiment, the preliminary filter 11 has a preliminary determining unit 116. The preliminary determining unit 116 is programmed with a preliminary determination threshold. If the preliminary processor unit 112 recognizes the new data record as a previously-stored data record, the preliminary determining unit 116 outputs the new data record that has been accessed for a number of times greater than or equal to the preliminary determination threshold to the preliminary output unit 114. If the number of times that the new data record has been accessed is lower than the preliminary determination threshold, this new data record is stored into the preliminary storage unit 113.

In one embodiment, the preliminary processor unit 112 may be programmed with a cycle period. The preliminary processor unit 112 regularly deletes data records from the preliminary storage unit 113 according to the cycle period, thereby resetting the preliminary storage unit 113. This prevents excessive data accumulation that obstructs correct determination so as to further improve the overall speed of data access in the computer and also prevent the hash data increasingly growing in the preliminary filter 11 from causing that all newly received data records are recognized as previously-stored data records.

The advanced filter 12 is coupled to the data-providing module 200 and the preliminary filter 11. The advanced filter 12 comprises a serial input unit 121, an advanced input unit 122, an advanced processor unit 123, an advanced storage unit 124, and an advanced output unit 125. The serial input unit 121 is coupled to the preliminary output unit 114 and serves to receive the preliminary data record and to store the preliminary data record into the advanced storage unit 124. It is to be noted that if the advanced filter 12 determines that there is a data record in the advanced storage unit 124 that is identical to the received preliminary data record, it does not repeatedly store or add it to the advanced filter 12. The advanced input unit 122 is coupled to the data-providing module 200 and serves to receive the new data record. The advanced processor unit 123 determines whether the new data record is a previously-stored data record. If yes, the advanced output unit 125 outputs an advanced data record.

In one embodiment, the advanced processor unit 123 determines whether the new data record is a previously-stored data record by searching the advanced storage unit 124 for any data record that is identical to the new data record. If there is a data record in the advanced storage unit 124 that is identical to the new data record, the advanced processor unit 123 recognizes the new data record as the advanced data record, and lets the advanced output unit 125 output the advanced data record. In this case, the identical data record in the advanced storage unit 124 is deleted by the advanced processor unit 123.

Referring to FIG. 4, in the present embodiment, the advanced filter 12 comprises an advanced hash unit 126. The advanced hash unit 126 receives and hashes the new data record so as to obtain a hashed-form data record. The advanced processor unit 123 determines whether the hashed-form data record is a previously-stored data record. As described previously, the advanced filter 12 may be a Bloom filter. Specifically, the advanced filter 12 may be a counting Bloom filter. Thus, with the use of the advanced hash unit 126, every new data record can be represented and stored in the hashed form. The advanced processor unit 123 determines whether there is any identical hashed-form data record at the corresponding storage site in the advanced storage unit 124. If yes, the advanced processor unit 123 recognizes the hashed-form data record as a previously-stored data record.

Referring to FIG. 4, in one embodiment, the advanced filter 12 has an advanced determining unit 127. The advanced determining unit 127 is programmed with an advanced determination threshold. If the advanced processor unit 123 determines that the new data record is a previously-stored data record, the advanced determining unit 127 outputs the new data record that has been accessed for the number of times greater than or equal to the advanced determination threshold to the advanced output unit 125. If the number of times that the new data record has been accessed is lower than the advanced determination threshold, this new data record is stored into the advanced storage unit 124.

In one embodiment, the advanced processor unit 123 is programmed with the cycle period. The advanced processor unit 123 regularly deletes data records from the advanced storage unit 124 according to the cycle period, thereby resetting the advanced storage unit 124. This prevents excessive data accumulation that obstructs correct determination so as to further improve the overall speed of data access in the computer and also prevent the hash data increasingly growing in the advanced filter 12 from causing that all newly received data records are recognized as previously-stored data records.

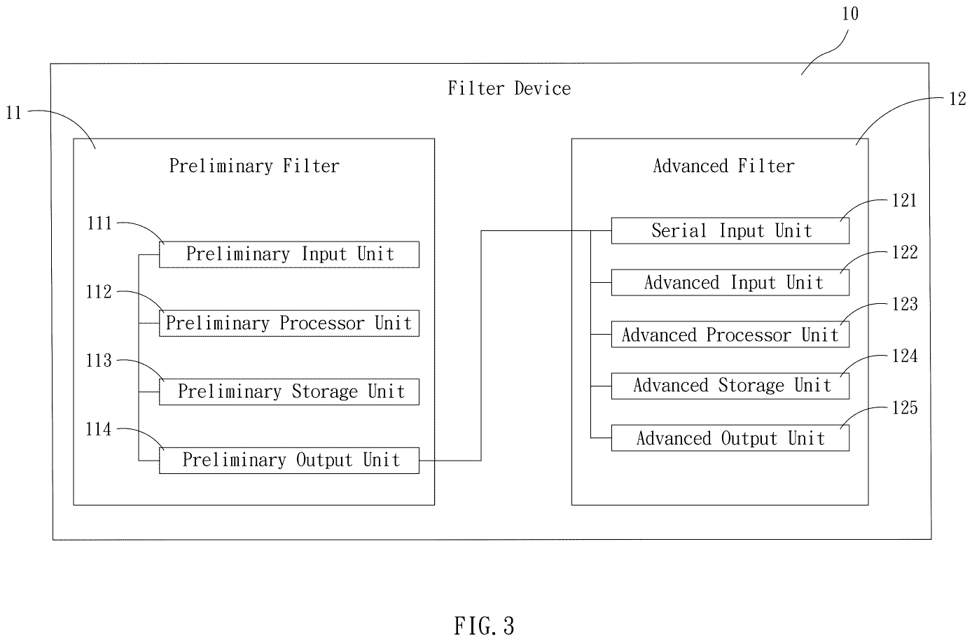

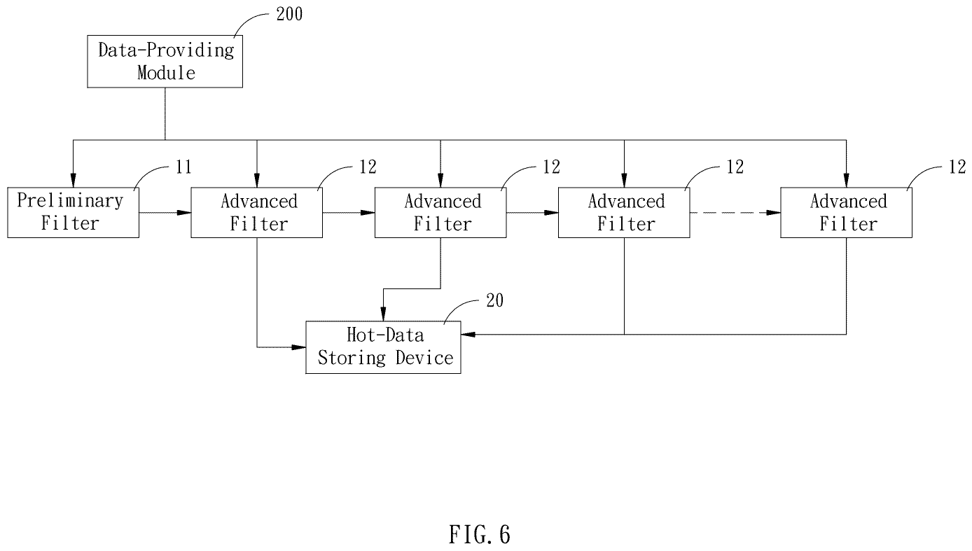

Referring to FIG. 3 and FIG. 6, in the present embodiment, there are plural advanced filters 12 serially connected to the advanced output unit 125 and the serial input unit 121 successively in a sequence. Each of the advanced filters 12 is coupled to the data-providing module 200 through the advanced input unit 122 contained therein and the last advanced filter 12 has its advanced output unit 125 coupled to the hot-data storing device 20. Therein, the advanced output unit 125 of each of the advanced filters 12 is also coupled to the hot-data storing device 20.

In one embodiment, each of the data records stored in the preliminary data record, the advanced data record, and the preliminary storage unit 113 as well as the advanced storage unit 124 is associated with a piece of hot information that represents the number of times it has been accessed. For example, if the advanced data record has been accessed for 4 times, the hot information represents the number of times (i.e., 4). Therein, when the preliminary output unit 114 outputs the preliminary data record, the preliminary processor unit 112 updates the hot information of the preliminary data record by increasing the number of times the data record has been accessed. When the advanced output unit 125 outputs the advanced data record, the advanced processor unit 123 similarly updates the hot information of the advanced data record by increasing the number of times the data record has been accessed.

The hot-data storing device 20 is coupled to the advanced filter 12 and stores the advanced data record. In one embodiment, the hot-data storing device 20 may be a Cuckoo cache. Thereby, with the characteristics of the Cuckoo cache about hashing and about mapping to at least two sites, fast query and update of data can be achieved with reduced memory occupation and improved efficiency in storing and searching data.

In one embodiment, when there are plural advanced filters 12, the advanced filters 12 are serially connected in a sequence. Therefore, the advanced data record output by the advanced output unit 125 that is later in the sequence has been accessed for more times. Thus, the hot-data storing device 20 preferentially stores the advanced data record output by the advanced output unit 125 of the advanced filter 12 that is later in the sequence.

Additionally, in one embodiment, the hot-data storing device 20 may be further programmed with a storage threshold related to the number of times a data record has been accessed. If a data record in the hot information has been accessed for the number of times greater than or equal to the storage threshold, the advanced data record is recognized as a hot data record and stored in the hot-data storing device 20. Otherwise, the hot-data storing device 20 does not store the advanced data record.

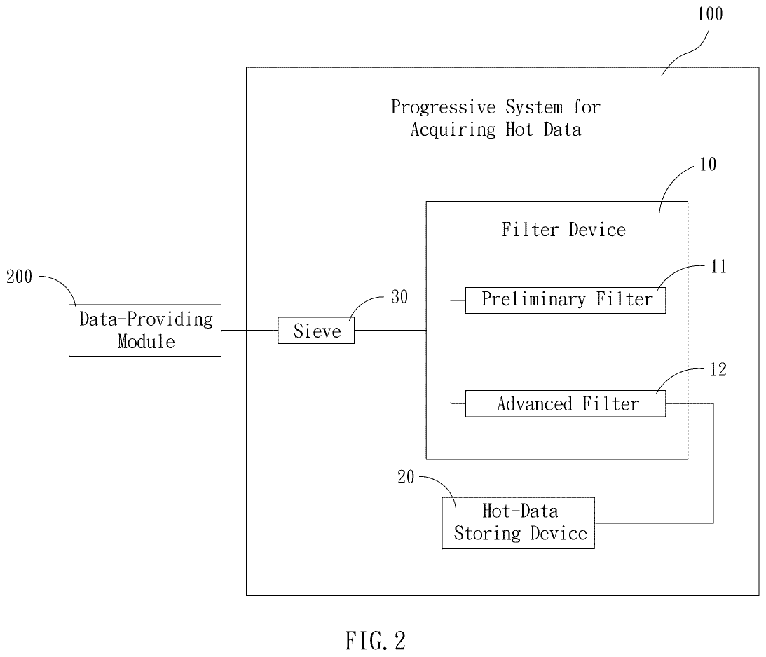

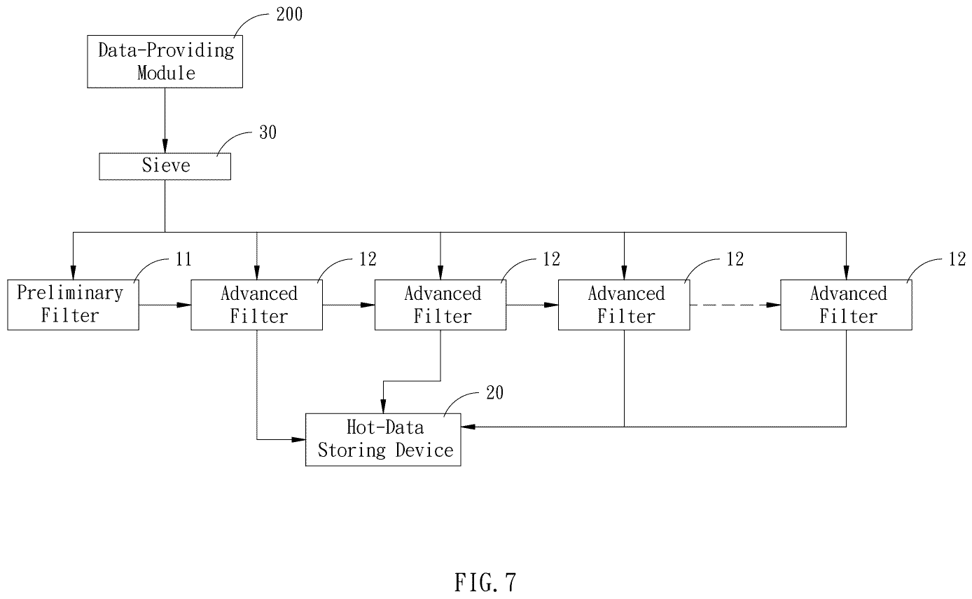

Referring to FIG. 2 and FIG. 7, this embodiment is different from its counterpart shown in FIG. 6 for it further comprises a sieve 30. The sieve 30 has its input end and output end coupled to the data-providing module 200 and the filter device 10, respectively. The sieve 30 receives the new data record and randomly inputs some of the new data records to the filter device 10 according to a predetermined sieving ratio. In an example where the sieving ratio is 20%, only 20 random data records among 100 new data records are delivered to the filter device 10. In the present embodiment, the sieve 30 may be a Morris counter. Thereby, when the data-providing module 200 inputs too many data records, the sieve 30 can, according to the principle of probability, effectively reduce workloads of the system for reading and processing hot data and improve the overall speeding of data processing without compromising the accuracy in recognizing hot data.

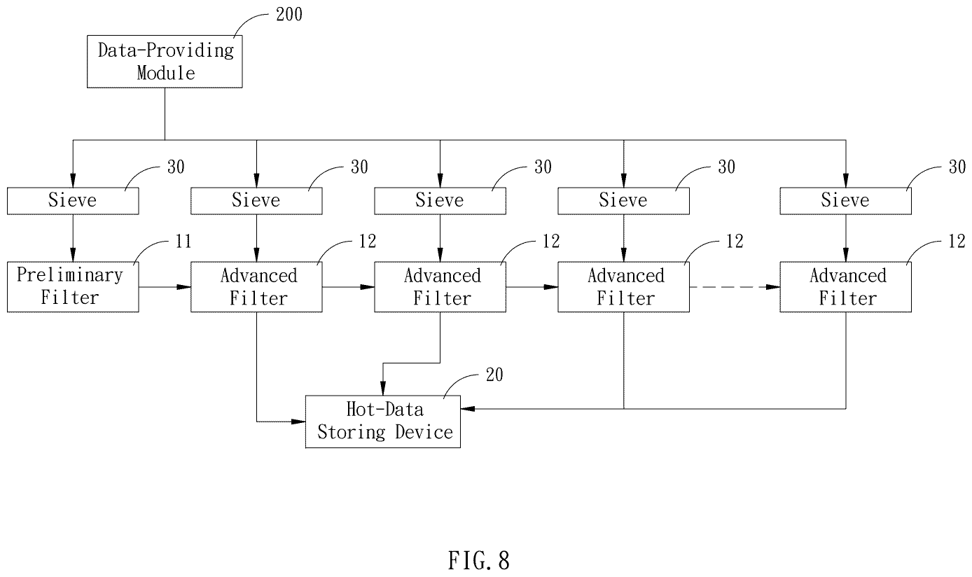

Referring to FIG. 8, this embodiment is different from its counterpart shown in FIG. 7 for it having plural sieves 30. Each of the sieves 30 has its input end coupled to the data-providing module 200 and has its output end coupled to the preliminary filter 11 and the advanced filter 12 separately. Thereby, the sieving ratio of each sieve 30 can be set independently according to practical needs to estimate the number of times hot data records have been accessed. For example, when each of the sieve 30 has the sieving ratio set at 100%, all new data records will pass. Therefore, if the first advanced filter 12 connected to the preliminary filter 11 receives a new data record and recognizes the new data record as a previously-stored data record, the new data record has been accessed for one time. Similarly, when the second advanced filter 12 following the first advanced filter 12 determines the new data record is a previously-stored data record, the new data record has been accessed for two times. However, if the sieving ratio of the first advanced filter 12 is set at 10%, only 10% of all new data records can pass. Thus, when the first advanced filter 12 receives a new data record and recognizes the new data record as a previously-stored data record, since the sieving ratio is 10%, according to the statistical conception, the number of times this new data record has been accesses shall be 10.

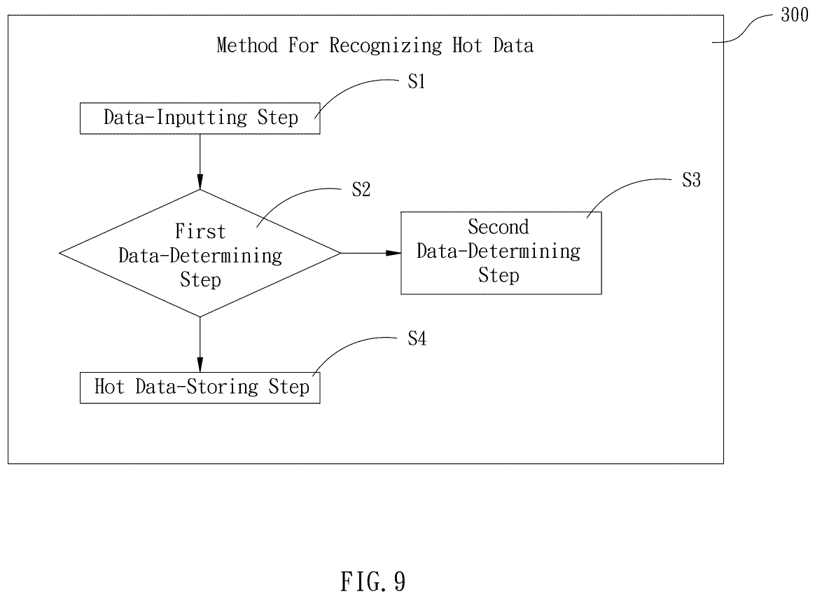

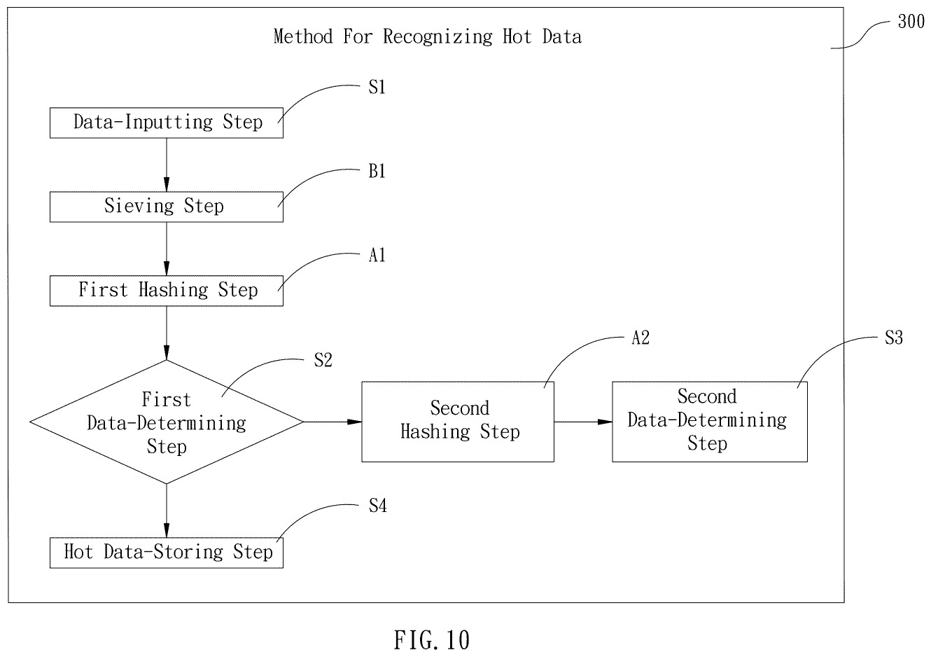

Referring to FIG. 9 and FIG. 10, this disclosure further provides a method for recognizing hot data 300 that works with the progressive system 100. The method comprises a data-inputting step S1, a first data-determining step S2, a second data-determining step S3, and a hot data-storing step S4.

At the data-inputting step S1, the data-providing module 200 provides the new data record to the filter device 10.

At the first data-determining step S2, it is determined whether the new data record is a previously-stored data record in the advanced filter 12 of the filter device 10. If no, the method proceeds with the second data-determining step S3. If yes, the advanced filter 12 outputs the advanced data record corresponding to the new data record, and the method proceeds with the hot data-storing step S4.

At the second data-determining step S3, it is to determine whether the new data record is a previously-stored data record in the preliminary filter 11 of the filter device 10. If no, the new data record is stored in the preliminary filter 11. If yes, the preliminary filter 11 outputs the preliminary data record corresponding to the new data record to the advanced filter 12.

At the hot data-storing step S4, the hot-data storing device 20 stores the advanced data record.

An embodiment is shown in FIG. 6. Therein, when there are plural advanced filters 12 serially connected successively in a sequence, at the first data-determining step S2, data recognition is performed in reverse order. That is, the process begins with the advanced filter 12 that is last in the sequence. If the new data record has been recognized as a previously-stored data record in the current advanced filter 12, and the current advanced filter 12 is last in the sequence, the current advanced filter 12 outputs the advanced data record corresponding to the new data record. If the new data record is a previously-stored data record in the current advanced filter 12 and the current advanced filter 12 is not last in the sequence, the current advanced filter 12 outputs the advanced data record corresponding to the new data record to the advanced filter 12 that follows in the sequence.

If the new data record is a previously-stored data record in the current advanced filter 12 and the current advanced filter 12 is last in the sequence, when the current advanced filter 12 outputs the advanced data record corresponding to the new data record, the current advanced filter 12 can opt to delete this previously-stored data record or keep this previously-stored data record in the advanced filter 12.

Further, it is to be noted that when there are plural advanced filters 12 serially connected in a sequence, in the hot data-storing step S4, the hot-data storing device 20 preferentially stores the advanced data record output by the advanced filter 12 that is later in the sequence.

Furthermore, in the first data-determining step S2, if the new data record is a previously-stored data record, the advanced filter 12 outputs the advanced data record corresponding to the new data record that has been accessed for a number of times that is greater than or equal to the advanced determination threshold. At the second data-determining step S3, if the new data record is a previously-stored data record, the preliminary filter 11 outputs the preliminary data record corresponding to the new data record that has been accessed for a number of times that is greater than or equal to the preliminary determination threshold.

Referring to FIG. 10, this embodiment is different from its counterpart shown in FIG. 9 for it further has a first hashing step A1 before the first data-determining step S2. Therein, the advanced filter 12 hashes the new data record to obtain the hashed-form data record. At the first data-determining step S2, it is to determine whether the hashed-form data record is a previously-stored data record in the advanced filter 12.

Similarly, before the second data-determining step S3, there is a second hashing step A2. Therein, the preliminary filter 11 hashes the new data record so as to obtain the hashed-from data record. At the second data-determining step S3, it is to determine whether the hashed-form data record is a previously-stored data record in the preliminary filter 11.

Additionally, in one embodiment, this disclosure further comprises a sieving step B1. Therein, the sieve 30 randomly inputs some of the new data records to the filter device 10 according to a predetermined sieving ratio.

Thereby, this disclosure has the following advantages:
1. With the filter device 10 and the hot-data storing device 20, this disclosure progressively recognizes and accesses hot data in a computer, so as to improve the overall speed of data access in the computer.
2. The predetermined cycle period programmed in the preliminary processor unit 112 and the advanced processor unit 123 ensures regular deletion of data, thereby further improving the overall speed of data access in the computer.
3. The sieve 30 randomly sieves data to further save steps for access data in the computer, thereby even further improving the overall speed of data access in the computer.

The present disclosure has been described with reference to the preferred embodiments and it is understood that the embodiments are not intended to limit the scope of the present disclosure. Moreover, as the contents disclosed herein should be readily understood and can be implemented by a person skilled in the art, all equivalent changes or modifications which do not depart from the concept of the present disclosure should be encompassed by the appended claims.

What is claimed is:

1. A progressive system for acquiring hot data, being used to access data in a computer and being connected to a data-providing module, the progressive system comprising:
a filter device, comprising:
a preliminary filter, comprising a preliminary input unit, a preliminary processor unit, a preliminary storage unit, and a preliminary output unit, wherein the preliminary input unit is coupled to the data-providing module and receives a new data record from the data-providing module, in which the preliminary processor unit determines whether the new data record is a previously-stored data record, and if yes, the preliminary output unit outputs a preliminary data record, or if no, the new data record is stored in the preliminary storage unit; and
an advanced filter, being coupled to the data-providing module and the preliminary filter, wherein the advanced filter comprises a serial input unit, an advanced input unit, an advanced processor unit, an advanced storage unit, and an advanced output unit, in which the serial input unit is coupled to the preliminary output unit and receives and stores the preliminary data record into the advanced storage unit, and the advanced input unit is coupled the data-providing module and receives the new data record, after which the advanced processor unit determines whether the new data record is a previously-stored data record, and if yes, the advanced output unit outputs an advanced data record; and
a hot-data storing device, being coupled to the advanced filter and storing the advanced data record.

2. The progressive system of claim 1, wherein the preliminary filter comprises a preliminary hash unit, which receives and hashes the new data record so as to obtain a hashed-form data record, and the preliminary processor unit determines whether the hashed-form data record is a previously-stored data record; and the advanced filter comprises an advanced hash unit, which receives and hashes the new data record so as to obtain the hashed-form data record, and the advanced processor unit determines whether the hashed-form data record is a previously-stored data record.

3. The progressive system of claim 2, wherein the preliminary filter is a Bloom filter, and the advanced filter is a Bloom filter.

4. The progressive system of claim 1, wherein the advanced filter is plural in number, and the advanced filters are serially connected to the advanced output unit and the serial input unit successively in a sequence, in which each of the advanced filters has the advanced input unit therein coupled to the data-providing module, and the advanced output unit of the advanced filter that is last in the sequence is coupled to the hot-data storing device.

5. The progressive system of claim 4, wherein each of the advanced filters has the advanced output unit coupled to the hot-data storing device.

6. The progressive system of claim 5, wherein the hot-data storing device preferentially stores the advanced data record output by the advanced output unit of the advanced filter that is later in the sequence.

7. The progressive system of claim 1, wherein the hot-data storing device is a Cuckoo cache.

8. The progressive system of claim 1, further comprising a sieve, which has an input end and an output end coupled to the data-providing module and the filter device, respectively, wherein the sieve receives the new data record and randomly input some of the new data records to the filter device according to a predetermined sieving ratio.

9. The progressive system of claim 8, wherein the sieve is plural in number and each of the sieves has the input end coupled to the data-providing module and has the output end coupled to the preliminary filter and the advanced filter separately.

10. The progressive system of claim 1, wherein the preliminary filter has a preliminary determining unit that is programmed with a preliminary determination threshold, so that if the preliminary processor unit recognizes the new data record as the previously-stored data record, the preliminary determining unit outputs the new data record that has been accessed for a number of times that is greater than or equal to the preliminary determination threshold to the preliminary output unit; and the advanced filter has an advanced determining unit that is programmed with an advanced determination threshold, so that if the advanced processor unit recognizes the new data record as a previously-stored data record, the advanced determining unit outputs the new data record that has been accessed for a number of times that is greater than or equal to the advanced determination threshold to the advanced output unit.

11. The progressive system of claim 1, wherein the preliminary processor unit and the advanced processor unit are programmed with a cycle period, so that the preliminary processor unit and the advanced processor unit regularly delete the data records from the preliminary storage unit and the advanced storage unit according to the cycle period.

12. A method for recognizing hot data using the system of claim 1, being used to access data in a computer, the method comprising:
a data-inputting step: using the data-providing module to provide the new data record to the filter device;
a first data-determining step: determining whether the new data record is a previously-stored data record in the advanced filter of the filter device, and if no, proceeding with a second data-determining step, or if yes, making the advanced filter output the advanced data record corresponding to the new data record, and performing a hot data-storing step;
the second data-determining step: determining whether the new data record is a previously-stored data record in the preliminary filter of the filter device, and if no, storing the new data record in the preliminary filter, or if yes, making the preliminary filter output the preliminary data record corresponding to the new data record to the advanced filter; and
the hot data-storing step: using the hot-data storing device to store the advanced data record.

13. The method of claim 12, wherein when the advanced filter is plural in number, and the advanced filters are serially connected in a sequence, at the first data-determining step, data recognition is performed by beginning with the advanced filter that is last in the sequence, and if the new data record has been recognized as a previously-stored data record in the current advanced filter and the current advanced filter is last in the sequence, the current advanced filter outputs the advanced data record corresponding to the new data record; or if the new data record is a previously-stored data record in the current advanced filter and the current advanced filter is not last in the sequence, the current advanced filter outputs the advanced data record corresponding to the new data record to the advanced filter that follows in the sequence.

14. The method of claim 13, wherein at the first data-determining step, if the new data record is a previously-stored data record in the current advanced filter and the current advanced filter is last in the sequence, when the current advanced filter outputs the advanced data record corresponding to the new data record, the current advanced filter opts to delete the previously-stored data record or keep the previously-stored data record in the advanced filter.

15. The method of claim 13, wherein at the hot data-storing step, the hot-data storing device preferentially stores the advanced data record output by the advanced filter that is later in the sequence.

16. The method of claim 12, further comprising a first hashing step before the first data-determining step, wherein at the first hashing step, the advanced filter hashes the new data record so as to obtain a hashed-form data record, and at the first data-determining step, it is to determine whether the hashed-form data record is a previously-stored data record in the advanced filter.

17. The method of claim 12, further comprising a second hashing step before the second data-determining step, wherein at the second hashing step, the preliminary filter hashes the new data record so as to obtain a hashed-form data record, and at the second data-determining step, it is to determine whether the hashed-form data record is a previously-stored data record in the preliminary filter.

18. The method of claim 12, further comprising a sieving step in which a sieve randomly inputs some of the new data records to the filter device according to a predetermined sieving ratio.

19. The method of claim 12, wherein at the first data-determining step, if the new data record is a previously-stored data record, the advanced filter outputs the advanced data record corresponding to the new data record that has been accessed for a number of times that is greater than or equal to an advanced determination threshold; and at the second data-determining step, if the new data record is a previously-stored data record, the preliminary filter outputs the preliminary data record corresponding to the new data record that has been accessed for a number of times that is greater than or equal to a preliminary determination threshold.

20. The method of claim 12, wherein the preliminary filter is a Bloom filter, and the advanced filter is a Bloom filter, while the hot-data storing device is a Cuckoo cache.
